(19) United States
(12) Patent Application Publication
(10) Pub. No.: US 2026/0186662 A1
(43) Pub. Date: Jul. 2, 2026

(54) Methods for sorting commands and memory controller utilizing the same

(71) Applicant: Silicon Motion, Inc., Hsinchu County (TW)

(72) Inventor: Cheng-Yu Lee, Hsinchu County (TW)

(73) Assignee: Silicon Motion, Inc., Hsinchu County (TW)

(21) Appl. No.: 19/057,898

(22) Filed: Feb. 19, 2025

(30) Foreign Application Priority Data
Jan. 2, 2025 (TW) 114100004

(51) Int. Cl. G06F 3/06

(52) U.S. Cl. CPC G06F 3/0613; G06F 3/0659; G06F 3/0679

(57) ABSTRACT

A method for sorting commands in a memory controller includes receiving multiple commands from a host device and storing the commands in a command queue of the memory controller; and sequentially adding the commands in a handle list. The command queue includes multiple slots and each slot corresponds to one command, and step of sequentially adding the commands in the handle list further includes sorting the commands in the handle list based on an order of receiving the commands and a default priority of respective commands.

### BACKGROUND OF THE INVENTION

### 1. Field of the Invention

The present invention is related to methods for sorting commands to improve access performance of a data storage device and a memory controller of the data storage device utilizing the same.

### 2. Description of the Prior Art

With the rapid growth of data storage technology in recent years, many data storage devices—such as memory cards manufactured in compliance with the Secure Digital (SD)/Multi Media Card (MMC) standards, Compact Flash (CF) standards, Memory Stick (MS) standards or Extreme Digital (XD) standards, as well as Solid State Disk (SSD) drives, Embedded Multi Media Cards (eMMC) and Universal Flash Storage (UFS)—have been used widely for a variety of purposes.

Generally, the host device issues commands, such as read commands or write commands, to the data storage device to access data stored in the data storage device. However, when the host device keeps issuing commands to the data storage device and the execution order of the commands is not properly arranged, it may lead to problems where certain commands can never be executed, thereby affecting the access performance of data storage devices.

Therefore, how to improve access performance of a data storage device is an important issue to be concerned.

### SUMMARY OF THE INVENTION

According to an embodiment of the invention, a memory controller comprises a command queue and a microprocessor. The command queue stores a plurality of commands received from a host device. The command queue comprises a plurality of slots and each slot corresponds to one command. The microprocessor fetches the plurality of commands from the command queue and sequentially adds the plurality of commands in a handle list. When sequentially adding the plurality of commands in the handle list, the microprocessor sorts the plurality of commands in the handle list based on an order of receiving the plurality of commands and a default priority of each of the plurality of commands.

According to an embodiment of the invention, a method for sorting commands, comprising: receiving a plurality of commands from a host device and storing the plurality of commands in a command queue, wherein the command queue comprises a plurality of slots and each slot corresponds to one command; and sequentially adding the plurality of commands in a handle list, wherein step of sequentially adding the plurality of commands in the handle list further comprises: sorting the plurality of commands in the handle list based on an order of receiving the plurality of commands and a default priority of each of the plurality of commands.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary block diagram of a data storage device according to an embodiment of the invention.

FIG. 2 shows a flowchart of a method for sorting commands according to an embodiment of the invention.

FIG. 3 is a schematic diagram showing the process of sequentially adding commands to the handle list and at the same time sorting the commands in the handle list according to an embodiment of the invention.

FIG. 4 shows a flowchart of a method for sorting commands according to another embodiment of the invention

### DETAILED DESCRIPTION

In the following, numerous specific details are described to provide a thorough understanding of embodiments of the invention. However, one of skilled in the art will understand how to implement the invention in the absence of one or more specific details, or relying on other methods, elements or materials. In other instances, well-known structures, materials or operations are not shown or described in detail in order to avoid obscuring the main concepts of the invention.

Reference throughout this specification to “one embodiment”, “an embodiment”, “one example” or “an example” means that a particular feature, structure or characteristic described in connection with the embodiment or example is included in at least one embodiment of a plurality of embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

In addition, in order to make the objects, features and advantages of the invention more comprehensible, specific embodiments of the invention are set forth in the accompanying drawings. This description is made for the purpose of illustrating the general principles of the invention and should not be taken in a limiting sense. It should be understood that the following embodiments can be implemented by software, hardware, firmware, or any combination thereof.

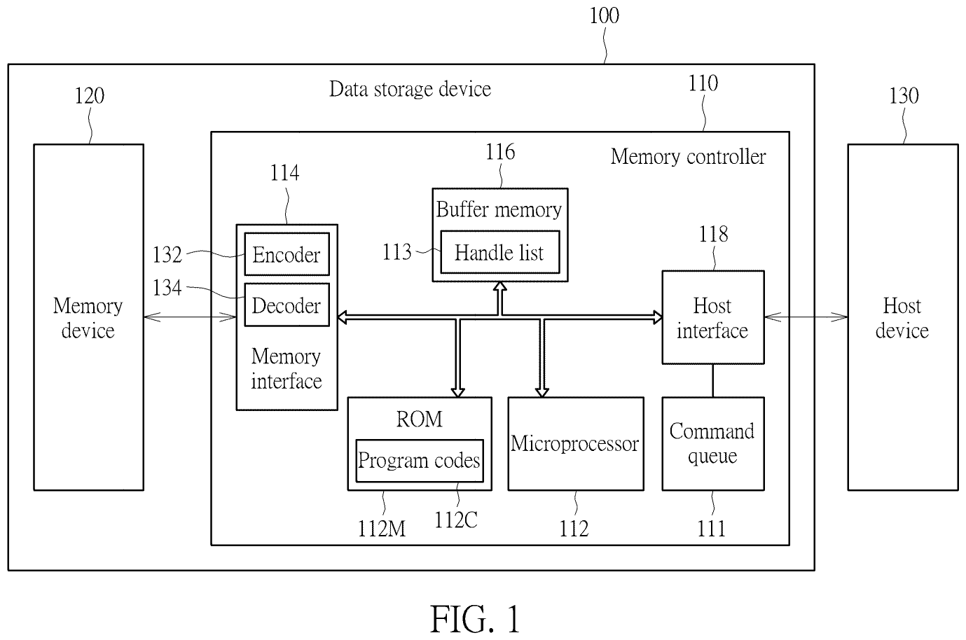

FIG. 1 shows an exemplary block diagram of a data storage device according to an embodiment of the invention. The data storage device 100 may comprise a memory device 120 and a memory controller 110. The memory controller 110 is configured to access the memory device 120 and control operations of the memory device 120. The memory device 120 may be a non-volatile (NV) memory (e.g., a Flash memory) device and may comprise one or more memory elements (e.g., one or more Flash memory dies, or one or more Flash memory chip, or the likes).

The data storage device 100 may be coupled to a host device 130. The host device 130 may at least comprise a processor, a power supply circuit and a random access memory (RAM), such as at least one dynamic RAM (DRAM), at least one static RAM (SRAM), etc. (not shown in FIG. 1). The processor and the RAM may be coupled to each other through a bus, and may be coupled to the power supply circuit to obtain power. The processor may be arranged to control operations of the host device 130. The power supply circuit may be arranged to provide the processor, the RAM and the data storage device 100 with power through the bus or the power lines. For example, the power supply circuit may output one or more driving voltages to the data storage device 100. The data storage device 100 may obtain the one or more driving voltages from the host device 130 as the power of the data storage device 100 and provide the host device 130 with storage space.

According to an embodiment of the invention, the memory controller 110 may comprise a command queue 111, a microprocessor 112, a read only memory (ROM) 112M, a memory interface 114, a buffer memory 116 and a host interface 118, where the microprocessor 112, the ROM 112M and the buffer memory 116 may form a control unit of the memory controller 110. The ROM 112M is configured to store program codes 112C. The microprocessor 112 is configured to execute the program codes 112C, thereby controlling access to the memory device 120. The program codes 112C may comprise one or more program modules, such as the boot loader code. When the data storage device 100 obtains power from the host device 130, the microprocessor 112 may perform an initialization procedure of the data storage device 100 by executing the program codes 112C. In the initialization procedure, the microprocessor 112 may load a group of In-System Programming (ISP) codes (not shown in FIG. 1) from the memory device 120. The microprocessor 112 may execute the group of ISP codes, so that the data storage device 100 has various functions. According to an embodiment of the invention, the group of ISP codes may comprise, but are not limited to: one or more program modules related to memory access (e.g., read, write and erase), such as a read operation module, a table lookup module, a wear leveling module, a read refresh module, a read reclaim module, a garbage collection module, a sudden power off recovery (SPOR) module and an uncorrectable error correction code (UECC) module, respectively provided for performing the operations of read, table lookup, wear leveling, read refresh, read reclaim, garbage collection, SPOR and error handling for detected UECC error.

The memory interface 114 may comprise an encoder 132 and a decoder 134. The encoder 132 is configured to encode the data to be written into the memory device 120, such as performing ECC encoding. The decoder 134 is configured decode the data read out from the memory device 120.

Typically, the memory device 120 may comprise a plurality of memory elements, such as a plurality of Flash memory dies or Flash memory chips, and each memory element may comprise a plurality of memory blocks. The access unit of an erase operation performed by the memory controller 110 on the memory device 120 may be one memory block. In addition, a memory block may record (comprise) a predetermined number of pages, for example, the physical pages, and the access unit of a write operation or a read operation performed by the memory controller 110 on the memory device 120 may be one page.

In practice, the memory controller 110 may perform various control operations by using its own internal components. For example, the memory controller 110 may use the memory interface 114 to control the access operations (especially the access operation for at least a memory block or at least a page) of the memory device 120, use the buffer memory 116 to perform necessary data buffer operations, and use the host interface 118 to communicate with the host device 130.

In an embodiment of the invention, the memory controller 110 may use the host interface 118 to communicate with the host device 130 in compliance with a standard communication protocol. For example, the standard communication protocol may comprise (but is not limited to) the Universal Serial Bus (USB) standard, the SD interface standard, the Ultra High Speed-I (UHS-I) interface standard, the Ultra High Speed-II (UHS-II) interface standard, the CF interface standard, the MMC interface standard, the eMMC interface standard, the UFS interface standard, the Advanced Technology Attachment (ATA) standard, the Serial ATA (SATA) standard, the Peripheral Component Interconnect Express (PCIe) standard, the Parallel Advanced Technology Attachment (PATA) standard, etc.

In an embodiment, the buffer memory 116 may be implemented by a RAM. For example, the buffer memory 116 may be an SRAM, but the invention should not be limited thereto. In other embodiments, the buffer memory 116 may be a DRAM.

In an embodiment of the invention, the data storage device 100 may be a portable storage device (for example, the memory card in compliance with the SD/MMC, CF, MS and/or XD standard), and the host device 130 may be an electronic device, such as a mobile phone, a notebook computer, a desktop computer . . . etc., capable of connecting to the data storage device. In another embodiment of the invention, the data storage device 100 may be a solid state hard disk or an embedded storage device in compliance with the UFS or the eMMC standards, and may be equipped in an electronic device such as a mobile phone, a notebook computer, or a desktop computer. In such an embodiment, the host device 130 may be a processor of the electronic device.

The host device 130 may issue commands, such as the read command or the write command, to the data storage device 100, so as to access the data stored in the memory device 120, or the host device 130 may issue commands to further control or manage the data storage device 100.

The command queue 111 may store a plurality of commands received from the host device 130. The command queue 111 may comprise a plurality of slots. Each slot may correspond to one command. When an execution of a command is completed, the microprocessor 112 responds to the host device 130 with an execution result, and the corresponding slot can be cleared. The host device 130 may further issue a new command to the data storage device 100.

Generally, the host device 130 may set a priority for a command, for example, by setting the corresponding priority in the attribute field of the command, and the commands with high priority will typically be executed as early as possible. However, if the host device 130 keeps issuing high-priority commands while some low-priority commands have not yet been executed, it may lead to the problems where certain previously received commands can never be executed as mentioned above, thereby affecting the access performance of the memory device in the storage device.

Scenarios that may cause the host device 130 to keeps issuing high-priority commands comprise: emergency data processing, database transaction processing, security updates, log recording, and system anomaly monitoring. For example, when processing real-time data streams (such as video data encoding or decoding), the host device 130 may continuously send high-priority read/write commands. Or, when processing critical database transactions, the host device 130 may continuously send high-priority input/output requests. Additionally, when the system performs emergency security updates, it may generate numerous high-priority write commands, or when the system sets log recording as high priority, it may continuously generate write commands under high load conditions. Furthermore, when the system detects abnormal conditions, it may trigger intensive logging and diagnostic operations, thereby generating consecutive high-priority input/output requests and issuing high-priority read/write commands.

To solve the aforementioned problem where certain received commands can never be executed and thereby affecting access performance of the memory device, according to an embodiment of the invention, the microprocessor 112 may fetch commands from the command queue 111 and place them in a handle list, such as handle list 113. The microprocessor 112 properly arranges the execution order of commands in the handle list to prevent situations where low-priority commands can never be executed.

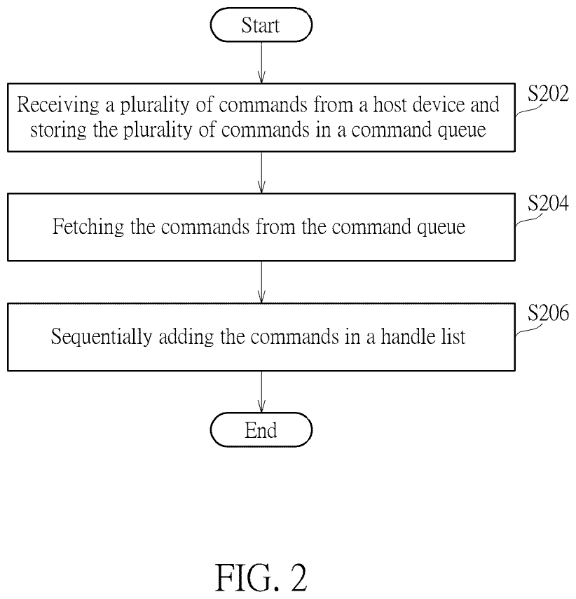

FIG. 2 shows a flowchart of a method for sorting commands according to an embodiment of the invention, including the following steps performed by the memory controller 110:
Steps S202: receiving a plurality of commands from a host device (e.g., the host device 130) and storing the plurality of commands in a command queue (e.g., the command queue 111). The command queue comprises a plurality of slots and each slot corresponds to one command.
Step S204: fetching the commands from the command queue.
Step S206: sequentially adding the commands in a handle list (e.g., the handle list 113).

According to an embodiment of the invention, the commands may be actually stored in the buffer memory 116, and the command queue 111 may store or record information regarding the storage address of the commands in the buffer memory 116. By recording the storage addresses, the microprocessor 112 may access the buffer memory 116 to obtain a command based on the content of the command queue 111 or a slot index of a corresponding slot in the command queue 111, and the overall operation may be equivalent to or can be regarded as storing commands in the command queue 111.

For example, in one embodiment, the content stored in each slot may be a storage address of the corresponding command in the buffer memory 116, and the microprocessor 112 may access the buffer memory 116 based on the storage address to obtain the command. In another embodiment, each slot may directly correspond to a memory space used to store the corresponding command in the buffer memory 116. Therefore, the microprocessor 112 may access the buffer memory 116 based on the slot index to obtain the command.

Therefore, in some embodiments of the invention, the operation of fetching commands from the command queue in step S204 may comprise the operation of reading information regarding the command from the command queue. Furthermore, in other embodiments of the invention, the operation of fetching commands from the command queue may comprise getting information regarding the commands and popping commands from the command queue. In yet other embodiments of the invention, step S204 may be omitted. It should be noted that the operations of steps S204 and S206 are intended to add information regarding the commands to the handle list based on the content stored in the command queue. Therefore, the invention is not limited to any specific implementation method.

According to an embodiment of the invention, when sequentially adding commands stored in the command queue 111 to the handle list 113, the microprocessor 112 may sort the commands in the handle list 113 based on an order of receiving these commands and a default priority corresponding to each of the commands.

More specifically, in one embodiment, the microprocessor 112 may determine a priority score for each command based on the default priority, and sequentially add the commands to the handle list 113 according to the priority score based on the order of receiving these commands.

According to an embodiment of the invention, the default priority is set by the host device 130. As mentioned above, the host device 130 may set the corresponding priority in the attribute field of the command. The memory controller 110 may configure corresponding hardware device, or the microprocessor 112 may read the attribute field of the command to obtain the priority set by the host device 130 as the default priority. In one embodiment, the hardware device may store the default priority information in a register to accelerate command processing. The microprocessor 112 may obtain the default priority corresponding to each command from the register and determine a priority score for each command based on the default priority.

According to an embodiment of the invention, the microprocessor 112 may set a corresponding score or value for each default priority, and use this score or value as the initial value of the priority score when adding commands to the handle list 113. According to an embodiment of the invention, the handle list 113 may record a slot

index and priority score corresponding to each command. In one embodiment, the operation of adding commands to the handle list 113 may also be regarded as storing commands in the handle list 113, where the handle list 113 may record the slot index and priority score corresponding to each command so as to store the commands.

According to an embodiment of the invention, the commands stored in the handle list 113 are sorted. The microprocessor 112 may sort the commands in the handle list 113 to generate a plurality of sorted commands. In other words, the sorted commands are a result of the microprocessor 112 sorting the commands in the handle list 113.

According to an embodiment of the invention, the order in which commands are stored in the handle list 113 is the order of the commands being executed by the microprocessor 112. The microprocessor 112 may sequentially execute the sorted commands from a beginning or start of the handle list 113, where the command positioned at the beginning or start of the handle list 113 is the command with the highest priority score in the handle list 113.

According to an embodiment of the invention, the handle list 113 may be stored in the buffer memory 116, and the invention is not limited to any specific implementation method for the handle list 113. For example, in one embodiment, the handle list 113 is an array. In another embodiment, the handle list 113 is a linked list. In yet another embodiment, the handle list 113 contains two sub-lists, one for sequentially storing slot indices corresponding to the commands, and another for sequentially storing priority scores corresponding to the commands. When a position of a command in the handle list 113 is changed, positions of the corresponding slot index and priority score stored in the two sub-lists will be changed as well. The order (e.g., chronological order) in which commands are executed may be defined by positions of the commands in the handle list 113.

According to an embodiment of the invention, the microprocessor 112 sequentially adds commands to the handle list 113 based on an order of receiving the commands, and during the process of sequentially adding commands to the handle list 113, the priority scores corresponding to the sorted commands in the handle list 113 may be dynamically adjusted by the microprocessor 112. According to an embodiment of the invention, the microprocessor 112 adjusts the priority scores corresponding to one or more commands whose positions have been changed due to the insertion of a new command in the handle list 113.

More specifically, in one embodiment, when an execution order (e.g., position in the handle list 113) of one of the sorted commands has been overtaken by another command (which may be the most recently added command to the handle list 113), the microprocessor 112 may raise the priority score of the overtaken command.

In the embodiments of the invention, the execution order being overtaken may refer to the scenario where the position of a command in the handle list 113 being moved in a direction away from the beginning or start of the handle list 113, or being moved toward the end or final position of the handle list 113. Alternatively, assuming the indices of positions in the handle list 113 are configured as an increasing sequence starting from the beginning of the handle list 113, a command with a relatively larger position index will be executed later. In this scenario, the execution order being overtaken may refer to situations where a command's position index is increased due to the insertion of a new command in the handle list 113.

According to an embodiment of the invention, before the microprocessor 112 inserts a predetermined command into the handle list 113, the microprocessor 112 may determine a position to insert the predetermined command in the handle list 113 according to its priority score, and when the determined position is not at the end of the handle list 113, the microprocessor 112 may raise the priority score of at least one sorted command in the handle list 113 based on the determined position.

In the embodiments of the invention, commands with higher priority scores are executed earlier. Therefore, in the scenario where position indices are configured as an increasing sequence starting from the beginning of the handle list 113, commands with higher priority scores will be placed closer to the beginning of the handle list 113 and have lower position indices.

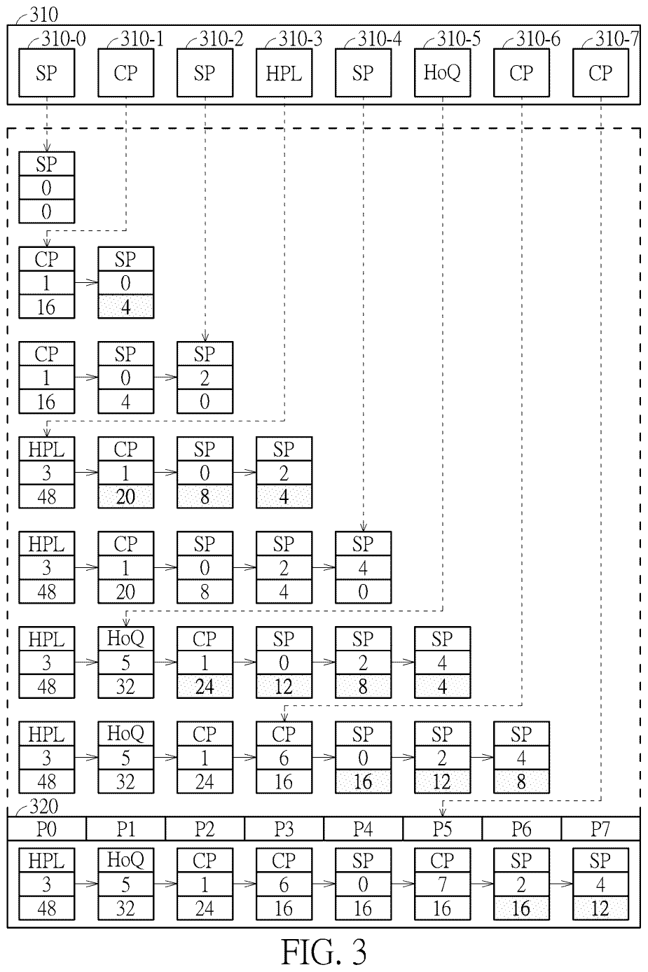

FIG. 3 is a schematic diagram showing the process of sequentially adding commands to the handle list and at the same time sorting the commands in the handle list according to an embodiment of the invention. FIG. 3 uses the four levels of command priority defined in the UFS specification as an example of default priorities, which include, from the highest to the lowest, HPL, HoQ, CP, and SP as shown in the FIG. 3, where HPL represents High Priority Logical unit number (LUN) with the highest priority, HoQ represents Head of Queue, CP represents Command Priority, and SP represents Simple with the lowest priority.

In this example, the command queue 310 comprises 8 slots for sequentially receiving commands from a host device (e.g., host device 130 shown in FIG. 1), and slot 310-0 stores a command with the priority set to SP, slot 310-1 stores a command with the priority set to CP, slot 310-2 stores a command with the priority set to SP, slot 310-3 stores a command with the priority set to HPL, slot 310-4 stores a command with the priority set to SP, slot 310-5 stores a command with the priority set to HoQ, slot 310-6 stores a command with the priority set to CP, and slot 310-7 stores a command with the priority set to CP, where slot 310-0 stores the earliest received command and slot 310-7 store the latest received command.

In this example, the score (e.g., priority score) corresponding to priority HPL is set to 48, the score corresponding to priority HoQ is set to 32, the score corresponding to priority CP is set to 16, and the score corresponding to priority SP is set to 0. Whenever the execution order of a command is overtaken, the microprocessor 112 increases its corresponding priority score by 4. Note that the values in this example are just one implementation of the invention and are utilized to illustrate the command sorting operations. In practice, these values can be flexibly configured based on factors such as latency requirements and importance of each priority level.

The microprocessor 112 may add the commands stored in the command queue 310 to the handle list based on the order the commands were received (i.e., in a chronological order). The handle list 320 shown at the bottom of FIG. 3 depicts the result after all commands currently stored in command queue 310 are added in the handle list 320 with the proposed command sorting method, where the handle list 320 comprise 8 storage spaces with corresponding position indices P0˜P7. Additionally, the content drawn from top to bottom between command queue 310 and handle list 320 in FIG. 3 shows the results produced step by step as commands are sequentially added to the handle list.

Furthermore, for each command stored in the handle list 320, three columns of information are shown to distinguish different commands, including the first column of the default priority (indicating the priority set by host device 130), the second column of slot index (indicating which slot of command queue 310 the corresponding command was fetched from), and the third column of priority score, where the priority score may be accordingly adjusted in response to the command sorting operations. To highlight adjustments of the priority scores, in FIG. 3, the priority scores that have been adjusted due to the insertion or addition of new commands are shown in bold with a background filled with dots. Operations for adding commands to the handle list 320 will be explained in more detailed in the following paragraphs.

As shown in FIG. 3, the microprocessor 112 first adds the command fetched from slot 310-0 with the priority set to SP to the handle list 320. At this time, the handle list 320 records one sorted command, which is fetched from the slot with index 0 in the command queue 310, and an index of the current position of the command in the handle list 320 is P0. In addition, an initial value of the priority score of this command is 0 since the priority of this command is set to SP.

Next, the microprocessor 112 adds a new command fetched from slot 310-1 with the priority set to CP to the handle list 320. Since the priority of this command is set to CP, an initial value of the priority score of this command is 16, which is higher than the priority score 0 of the SP command, the position for inserting this command CP is determined to be P0 and the sorted command SP in the handle list 320 is moved to P1. Since the execution order of the sorted command SP has been overtaken, the microprocessor 112 raises the priority score of the sorted command SP from 0 to 4 while moving the sorted command SP. Next, the microprocessor 112 adds the command fetched from slot 310-2 with the priority set to SP to the handle list 320. Since the priority of this command is set to SP, an initial value of the priority score of this command is 0, and position for inserting this command is determined to be P2, which is also at the end of the current handle list 320.

Next, the microprocessor 112 adds the command fetched from slot 310-3 with the priority set to HPL to the handle list 320. Since the priority of this command is set to HPL, an initial value of the priority score of this command is 48, which is higher than all the sorted commands currently stored in handle list 320. Therefore, position for inserting this command is determined to be P0, and all other sorted commands are moved toward the end of the handle list 320. Furthermore, since the execution order of all sorted commands in the handle list 320 has been overtaken, the microprocessor 112 increases the respective priority scores by 4 while moving these sorted commands.

Next, the microprocessor 112 adds the command fetched from slot 310-4 with the priority set to SP to the handle list 320. Since the priority of this command is set to SP, an initial value of the priority score of this command is 0, and position for inserting this command is determined to be P4, which is now at the end of the current handle list 320.

Next, the microprocessor 112 adds the command fetched from slot 310-5 with the priority set to HoQ to the handle list 320. Since the priority of this command is set to HoQ, an initial value of the priority score of this command is 32, which is higher than the command CP at the position P1 but lower than the command HPL at the position P0. Therefore, position for inserting this command HoQ is determined to be P1. The sorted commands originally arranged at the positions P1-P4 are moved to the positions P2-P5, and the microprocessor 112 increases the respective priority scores by 4 while moving these sorted commands.

Next, the microprocessor 112 adds the command fetched from slot 310-6 with the priority set to CP to the handle list 320. Since the priority of this command is set to CP, an initial value of the priority score of this command is 16, and position for inserting this command CP is determined to be P3. The sorted commands originally arranged at the positions P3-P5 are moved to the positions P4-P6, and the microprocessor 112 increases the respective priority scores by 4 while moving these sorted commands.

Next, the microprocessor 112 adds the command fetched from slot 310-7 with the priority set to CP to the handle list 320. Since the priority of this command is set to CP, an initial value of the priority score of this command is 16, and position for inserting this command CP is determined to be P5. The sorted commands originally arranged at the positions P5-P6 are moved to the positions P6-P7, and the microprocessor 112 increases the respective priority scores by 4 while moving these sorted commands.

Through the above operations, it can be observed that when the microprocessor 112 adds the command fetched from slot 310-7 with the priority set to CP to handle list 320, even though the default priority of this command is CP, which is higher than SP, the microprocessor 112 determines the position for inserting this command fetched from slot 310-7 to be P5 because the priority score of the command fetched from slot 310-0 with the priority set to SP has been raised to 16, so the execution of this CP command will be later than the SP command at position P4. In other words, the microprocessor 112 will no longer let the execution of the command fetched from slot 310-7 with the priority set to CP overtake the execution of the command fetched from slot 310-0 with the priority set to SP, thereby effectively preventing the situation where commands issued earlier by host device 130 cannot be executed due to their lower default priority.

In the embodiments of the invention, the sorted commands in the handle list 320 are sequentially executed from the beginning of the handle list (for example, from position P0). Furthermore, when the microprocessor 112 completes executing a command, the host device 130 may issue a new command to the data storage device 100. The microprocessor 112 may keep polling the command queue 111/310 to confirm whether one or more new commands has or have been received. In response to reception of one or more new commands, the microprocessor 112 may repeat the aforementioned command sorting operation, that is, determine the corresponding priority scores based on the default priorities of the new commands, and sequentially add the new commands to the handle list according to the corresponding priority scores based on the order in which the commands are received. When adding new commands to the handle list, the microprocessor 112 may dynamically adjust the priority scores corresponding to the sorted commands in the handle list, so that the order or the arrangement of the commands in the handle list not only meets the priority requirements of the host device 130 but also considers the processing delay of earlier received commands (especially low-priority commands). By increasing their priority scores, the low-priority commands previously received can be executed in a timely manner, avoiding situations where executions of earlier received low-priority commands are kept being overtaken by later received high-priority commands and are never executed, or are executed after a long time.

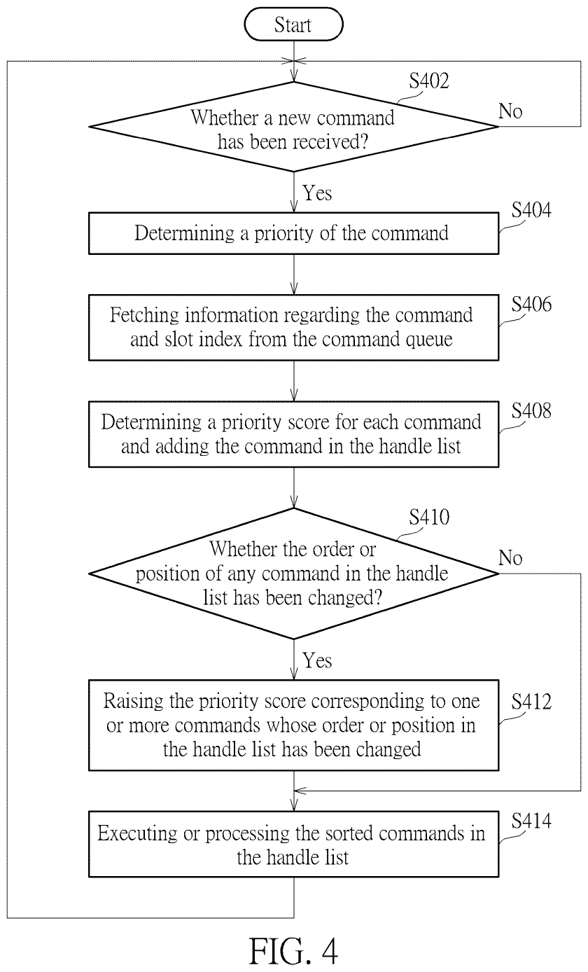

FIG. 4 shows a flowchart of a method for sorting commands according to another embodiment of the invention, including the following steps performed by the microprocessor 112:
Step S402: checking whether a new command has been received. As mentioned above, the microprocessor 112 may keep polling the command queue 111/310 to check whether a new command has been received. When determining that a new command has been received, step S404 is performed.
Step S404: determining a priority of the command. For example, in the embodiments of sorting command based on the command priorities defined in the UFS specification, which of the priority HPL, HoQ, CP or SP of the command is set to is determined. Or in other embodiments, which default priority is set by the host device 130 is determined.
Step S406: fetching information regarding the command and slot index from the command queue. In one embodiment of the invention, the operation of fetching the command from the command queue comprises fetching or getting commands (e.g., information regarding the commands) and popping the commands from the command queue.
Step S408: determining a priority score for each command and adding the command in the handle list. As mentioned above, the microprocessor 112 may determine a position for inserting the command according to the priority score, so that the commands in the handle list may be arranged in manner where the corresponding priority score are descending (or ascending in other embodiments), thereby generating sorted commands.
Step S410: determining whether the order or position of any command in the handle list has been changed (or, the execution order has been overtaken). When the determination result is yes, step S412 is performed. When the determination result is no, step S414 is performed.
Step S412: raising the priority score corresponding to one or more commands whose order or position in the handle list has been changed.
Step S414: executing or processing the sorted commands in the handle list.

Note that the microprocessor 112 may sequentially execute or process the sorted commands in the handle list, or may execute or process a batch of sorted commands in the handle list. The invention is not limited to any particular implementation method.

As mentioned above, the proposed method for sorting commands not only meets the priority requirements of the device issuing the commands (such as the host device), but also considers the processing delay of earlier received commands (especially low-priority commands). By dynamically adjusting (e.g., increasing) the priority scores, the low-priority commands received earlier can be executed in a proper time, avoiding situations where earlier received low-priority commands are kept being overtaken by later received high-priority commands and are never executed, or will be executed after a long time (which may be longer than or exceed a preset queuing time or exceed a maximum allowed processing delay set by the overall system).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory controller, comprising:
a command queue, storing a plurality of commands received from a host device, wherein the command queue comprises a plurality of slots and each slot corresponds to one command; and
a microprocessor, fetching the plurality of commands from the command queue and sequentially adding the plurality of commands in a handle list,
wherein when sequentially adding the plurality of commands in the handle list, the microprocessor sorts the plurality of commands in the handle list based on an order of receiving the plurality of commands and a default priority of each of the plurality of commands.

2. The memory controller of claim 1, wherein the microprocessor determines a priority score for each of the plurality of commands based on the corresponding default priority, and sequentially adds the plurality of commands to the handle list according to the priority score of each of the plurality of commands based on the order of receiving the plurality of commands.

3. The memory controller of claim 2, wherein the handle list records a slot index and the priority score of each of the plurality of commands.

4. The memory controller of claim 2, wherein the microprocessor sorts the plurality of commands in the handle list to generate a plurality of sorted commands, and the processor further dynamically adjusts one or more of the priority scores corresponding to the plurality of sorted commands in the handle list.

5. The memory controller of claim 4, wherein the microprocessor sequentially executes the plurality of sorted commands from a beginning of the handle list.

6. The memory controller of claim 4, wherein when an execution order of a sorted command in the handle list has been overtaken, the microprocessor raises the priority score corresponding to the sorted command.

7. The memory controller of claim 1, further comprising:
a buffer memory, storing the handle list and the plurality of commands,
wherein each slot of the command queue stores information regarding a storage address of the corresponding command in the buffer memory.

8. The memory controller of claim 1, wherein the default priority of each of the plurality of commands is set by the host device.

9. A method for sorting commands, comprising:
receiving a plurality of commands from a host device and storing the plurality of commands in a command queue, wherein the command queue comprises a plurality of slots and each slot corresponds to one command; and
sequentially adding the plurality of commands in a handle list,
wherein step of sequentially adding the plurality of commands in the handle list further comprises:
sorting the plurality of commands in the handle list based on an order of receiving the plurality of commands and a default priority of each of the plurality of commands.

10. The method of claim 9, wherein step of sorting the plurality of commands in the handle list based on the order of receiving the plurality of commands and the default priority of each of the plurality of commands further comprises:
determining a priority score for each of the plurality of commands based on the corresponding default priority; and
sequentially adding the plurality of commands to the handle list according to the priority score of each of the plurality of commands based on the order of receiving the plurality of commands.

11. The method of claim 10, wherein the handle list records a slot index and the priority score of each of the plurality of commands.

12. The method of claim 10, wherein step of sorting the plurality of commands in the handle list based on the order of receiving the plurality of commands and the default priority of each of the plurality of commands further comprises:
dynamically adjusting one or more of the priority scores corresponding to a plurality of sorted commands in the handle list, wherein the plurality of sorted commands in the handle list are generated by sorting the plurality of commands in the handle list.

13. The method of claim 12, wherein the plurality of sorted commands are executed from a beginning of the handle list.

14. The method of claim 12, wherein step of dynamically adjusting one or more of the priority scores corresponding to the plurality of sorted commands in the handle list further comprises:
raising the priority score corresponding to a sorted command when an execution order of the sorted command in the handle list has been overtaken.

15. The method of claim 9, wherein the default priority of each of the plurality of commands is set by the host device.
